(19) United States
(12) Patent Application Publication
(10) Pub. No.: US 2003/0203087 A1
(43) Pub. Date: Oct. 30, 2003

(54) Method and apparatus for a food delivery container

(76) Inventors: Boris E. Goldman, Newtown, CT (US); Michael E. Portnoy, Newtown, CT (US)

Correspondence Address: James J. Merrick, Cantor Colburn LLP, 55 Griffin Road South, Bloomfield, CT, 06002, US

(21) Appl. No.: 10/439,220

(22) Filed: May 15, 2003

Related U.S. Application Data
(63) Continuation-in-part of application No. 09/910,203, filed on Jul. 20, 2001.

(51) Int. Cl. C12C 3/04

(52) U.S. Cl. 426/392

(57) ABSTRACT

Disclosed herein is a food transportation container comprising an interior space defined within an arrangement of a top, a bottom, and a plurality of sides; and a radiant energy barrier disposed within the interior space of the container, the radiant barrier further configured to minimize at least one of convection loss and conduction loss from the interior space; the radiant energy barrier comprising a first layer at least partially separated from a second layer by an air space, wherein the first layer, the second layer, or both layers comprise a material capable of reflecting radiant energy, and wherein the airspace is in fluid communication with the interior space of the container through a plurality of perforations disposed within the first layer, the second layer, or both layers of the radiant energy barrier.

### CROSS REFERENCE TO RELATED APPLICATIONS

This is a continuation-in-part of application Ser. No. 09/910,203 filed on Jul. 20, 2001, which is herein incorporated by reference.

### BACKGROUND

It is customary for food products suitable for home delivery including, for example, pizza, Asian food, and the like collectively, referred to herein as pizza to be prepared for take-out by customers, and/or for delivery to the house of the person who places an order by telephone, facsimile, internet, and the like. One format for packaging pizza is to place the prepared thermally hot pizza in a single-walled, paper-board box that folds up from a flat paper-board blank to form a box enclosed with a lid.

While boxes of this type provide an economical food transportation container, they provide only a moderate degree of heat retention during delivery. Furthermore, water vapor emitted by the hot pizza subsequently condenses on the lid of the box, and so an extended delivery period can result in a pizza that is both cool and soggy. Large bulky insulated bags can be used by delivery services, but few consumers utilize the bags for their takeout food. However, these bags do not effectively stop heat loss caused by convection and radiation.

This same situation extends to delivery food intended to be served at lower than room temperature such as, for example, ice cream. Heat flow from an external environment into a refrigerated food results in the melting or otherwise spoiling of the food upon extended periods of exposure during home delivery.

Accordingly, there is a need for a food transportation container, which will maintain the food in a heated state (or a refrigerated state) during delivery, or simply over an elapsed period of time. Preferably, the container is economical to use, disposable, lightweight, and can be effectively used by restaurants and consumers alike to limit heat loss (or heat gain) due to radiation, convection, or conduction, including combinations of at least one of the foregoing.

### SUMMARY

Disclosed herein is a food transportation container comprising an interior space defined within an arrangement of a top, a bottom, and a plurality of sides; and a radiant energy barrier disposed within the interior space of the container; the radiant energy barrier comprising a first layer at least partially separated from a second layer by an air space, wherein the first layer, the second layer, or both layers comprise a material capable of reflecting radiant energy, and at least one of trapping convection currents, and minimizing heat conduction. The airspace is in fluid communication with the interior space of the container through a plurality of perforations disposed within the first layer, the second layer, or both layers of the radiant energy barrier.

Also disclosed herein is a food transportation container comprising a radiant energy barrier configured and dimensioned to define an interior space having an opening; the radiant energy barrier comprising a first layer at least partially separated from a second layer by an air space, wherein the first layer, the second layer, or both layers comprise a material capable of reflecting radiant energy, and at least one of trapping convection currents and minimizing heat conduction. The airspace is in fluid communication with the interior space of the container through a plurality of perforations disposed within the first layer of the radiant energy barrier.

Further disclosed is a method for reducing heat transfer in a food item during transportation of the food item, comprising: inserting a food item having a temperature different from a temperature of an external environment into a food transportation container; and transporting the food item within the container, wherein the container comprises a first container, a second container or a combination comprising at least one of the foregoing: the first container comprising an interior space defined within an arrangement of a top, a bottom, and a plurality of sides; and an internal radiant energy barrier disposed within the interior space of the first container; the internal radiant energy barrier comprising a first layer at least partially separated from a second layer by an air space, wherein the first layer, the second layer, or both layers comprise a material capable of reflecting radiant energy and at least one of blocking convection and radiation. The airspace between the two layers is in fluid communication with the interior space of the first container through a plurality of perforations disposed within the first layer, the second layer, or both layers of the internal radiant energy barrier; the second container comprising an external radiant energy barrier configured and dimensioned to define an interior space within the second container and having an opening; the second radiant energy barrier comprising an inner layer at least partially separated from an outer layer by an air space, wherein the inner layer, the outer layer, or both layers comprise a material capable of reflecting radiant energy and at least one of blocking convection and radiation. The airspace between the two layers is in fluid communication with the interior space of the second container through a plurality of perforations disposed within the inner layer of the radiant energy barrier. The outer layer optionally includes a single perforation as well.

### BRIEF DESCRIPTION OF THE DRAWINGS

FIG. 1 is a perspective view of an exemplary embodiment of a food container having its lid in the open position to reveal the heated food product;

FIG. 2 is a perspective view of the food container of FIG. 1 having a lid in a closed position;

FIG. 3 is an exploded view of a radiant energy barrier;

FIG. 4 is a cross sectional view of a radiant energy barrier;

FIG. 5 is an embodiment of a collapsible bag and box; and

FIG. 6 is a collapsible bag with a draw string

### DETAILED DESCRIPTION

Disclosed herein is a food transportation container directed to packages for take out and/or delivery food, in particular for the delivery of pizza. The food transportation container having a radiant energy barrier.

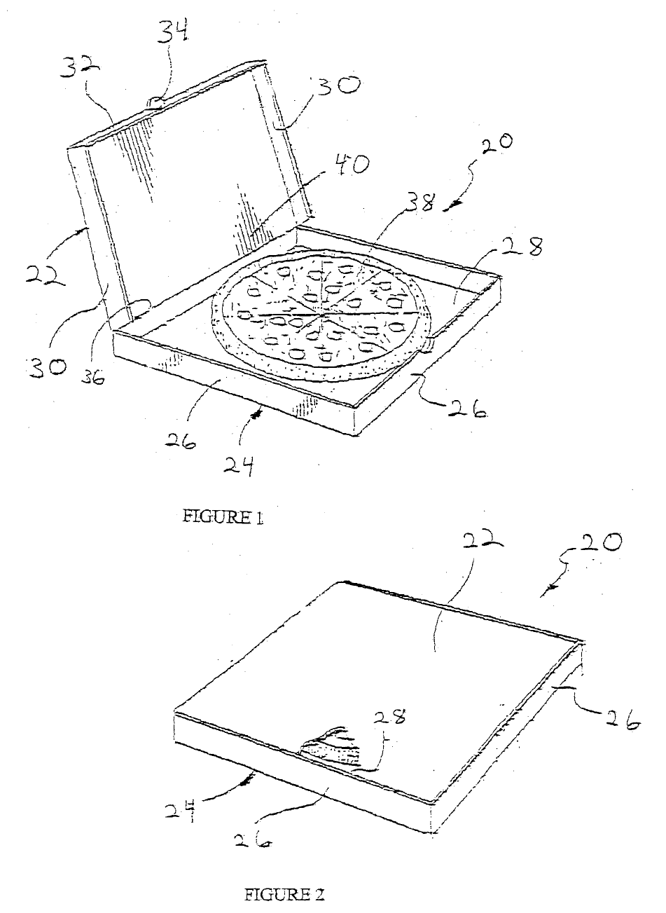

The embodiment of the food transportation container 20 shown in FIGS. 1 and 2 includes a top portion or lid 22, a bottom portion 24, and a plurality of sides 26 depending from the bottom portion 24, and which define an interior space 28. A pizza 38 is shown disposed within the interior space 28. In the embodiment shown, the container 20 is formed from a rigid material, such as, for example, fiber board (e.g., cardboard).

The lid 22 shown is hingedly attached to one of the sides 26 and includes integrally formed downwardly depending side walls 30 and a front wall 32. A centrally located tab 34 is disposed on/in front wall 32 and is used to facilitate opening and closing of the lid 22. The lid 22 is adapted to be folded downwardly about a score line 36 to a closed position wherein the side walls 30 and the front wall 32 of the lid 22 are located within the interior space 28, as depicted in FIG. 2.

Once the lid 22 is positioned in the closed position with a hot pizza 38 located in the interior space 28, the air contained in the interior space 28 becomes heated through convection from pizza 38. To reduce and/or prevent the heat from dissipating out of the container, a radiant barrier 40 is positioned within the interior space 28. Preferably, the radiant barrier 40 is attached to at least a portion of the lid 22 within the interior space 28. Radiant barrier 40 then reflects the radiating heat back towards the pizza 38, thus preventing and/or minimizing dissipation of the heat from the food transportation container 20. Radiant barrier is also preferably configured to minimize or block heat loss due to at least one of convection and conduction. In this manner, it will be recognized by one skilled in the pertinent art that the radiant barrier 40 is optionally disposed on the interior, middle, or the exterior portions defining container 20, including combinations of the foregoing.

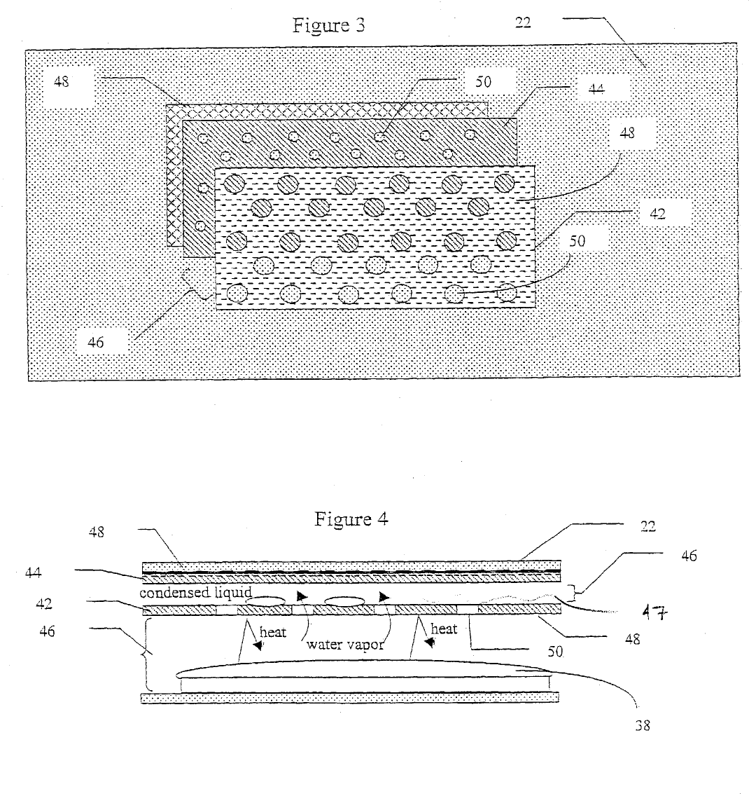

Turning now to FIG. 3, radiant barrier 40 comprises a plurality of layers including a first layer 42, at least partially separated from a second layer 44 by an air space. At least one of first layer 42, and/or the second layer 44, is/are capable of reflecting radiant energy.

Preferably, radiant barrier 40 is thin, having a total thickness less than or equal to about 1 cm, preferably less than or equal to about 0.5 cm, with a thickness less than or equal to about 10 to about 15 mm being most preferred. Also preferably, the radiant barrier 40 is flexible in that it easily conforms to the surface to which it is attached.

The layers of the radiant barrier 40 can each have a thickness of about 2.5 to about 250 micrometers (about 0.1 to about 10 mils). Within this range, a thickness of less than or equal to about 100 micrometers can be employed, with less than or equal to about 50 preferred, and less than or equal to about 25 more preferred. Also preferred within this range is a thickness of greater than or equal to about 5, with greater than or equal to about 10 more preferred, and greater than or equal to about 15 micrometers especially preferred.

Each layer that forms the radiant barrier may be single layer, or may a laminate comprising a plurality of different and/or identical layers. The layers are preferably a polymeric sheet or metallized cloth, and more preferably a metallized polymeric sheet. The polymeric sheet may comprise a thermosetting resin, an elastomeric resin, a thermoplastic resin, or a combination comprising at least one of the foregoing. It will be understood that as the optical density of the metallized polymer increases, the amount of heat reflected therefrom also increases.

Thermosetting resins include, for example, alkyds, diallyl phthalates, epoxies, melamines, phenolics, polyesters, urethanes, rigid silicones, and the like. Elastomeric resins include, for example, acrylates, butyls, chlorosulfonated polyethylene, fluorocarbons, fluorosilicones, polysulfides, polyurethanes, neoprenes, nitriles, silicones, styrene, butadienes, and the like. Thermoplastic resins include, for example, acetates, acrylics, cellulosics, chlorinated polyethers, fluorocarbons, nylons (polyamides), polycarbonates, polyesters, polyethylenes, polypropylenes, polyimides, polyphenylene oxides, polystyrenes, polysulfones, vinyls, and the like.

The layers may also comprise an oriented film and/or layer such as, for example, a monoaxially oriented layer, a biaxial oriented layer, or a combination comprising at least one of the foregoing. Orientation of the layers may be accomplished by heating the polymer to a temperature at or above its glass-transition temperature, but below its crystalline melting point and then stretching the film quickly. On cooling, the molecular alignment imposed by the stretching competes favorably with crystallization and the drawn polymer molecules condense into a crystalline network with crystalline domains aligned in the direction of the drawing force.

Preferably the layers comprise a metallized sheet. Metallized sheets include polymeric materials having a metallic or metallic like coating, layer or the like, disposed on and/or in the sheet. Metallized sheets may be produced by vacuum metallization, film coating or the like, to obtain a metal-like appearance and to enhance the barrier characteristics of the sheet. The metallized layer has a thickness of about 0.01 to about 20 micrometers (about 0.0004 to about 0.8 mils). Within this range, a thickness of less than or equal to about 15 micrometers can be employed, with less than or equal to about 10 micrometers preferred, and less than or equal to about 5 micrometers more preferred. Also preferred within this range is a thickness of greater than or equal to about 0.1 micrometers with greater than or equal to about 0.5 micrometers more preferred, and greater than or equal to about 1 micrometer especially preferred.

A preferred embodiment includes a layer having a metallized sheet comprising aluminum and oriented polyethylene, polypropylene, or a combination comprising at least one of the foregoing, and having a thickness of about 1 to about 5 micrometers.

The layers may also include a thermal convection barrier 48 to further reduce the transfer of heat into or out of the container either as a separate layer 48 and/or as an integral portion of a layer. Preferably, the thermal convection barrier includes polyethylene, polypropylene, or a combination comprising at least one of the foregoing materials of sufficient density and thickness to reduce the transfer of heat both in and out of the container.

At least two of the layers are at least partially separated from one another by airspace 46. The layers may be attached around the periphery to form air space 46, and/or may be attached at various locations throughout the radiant barrier 40. At least one of the layers includes a plurality of perforations 50 disposed within it. Accordingly, placement of the radiant barrier 40 within, a food transportation container 20 places the interior space of the container 28 in fluid communication with the air space 46.

The perforations 50 may define any geometric shape including, for example, a circle, an oval, a diamond, a square, a rectangle, or a combination comprising at least one of the foregoing. When more than one layer includes a plurality of perforations 50, the layer disposed in closest proximity to the interior space 28 of the container wherein the food whose temperature is to be maintained is located, preferably has perforations which define a larger surface area than do the perforations on the layer a further distance away. Furthermore, the layers may be treated to impart hydrophilic character, and/or hydrophobic character in different locations to assist in this process. In one contemplated embodiment with reference to FIG. 4, for example, an absorbent layer 47 is optionally disposed within air space 46. Absorbent layer 47 is configured to limit condensed liquid from combining with the food which emits the water vapor that forms the condensed liquid. Absorbent layer 47 may occupy a portion or all of air space 46. It will also be recognized that perforations 50 and absorbent layer 47 may be employed in food container 20 configured as a box or a bag. The perforations 50 each have a length along a major axis of about 1 to about 25 millimeters (mm). Within this range, a length of less than or equal to about 20 can be employed, with less than or equal to about 18 preferred, and less than or equal to about 15 more preferred. Also preferred within this range is a length of greater than or equal to about 2, with greater than or equal to about 5 more preferred, and greater than or equal to about 10 mm especially preferred.

Not wishing to be bound by theory, the perforations allow for the water vapor emanating from the warm food (e.g., hot steaming pizza) to travel into the airspace 46 and then condense within the air space away from the food (see FIG. 4). Accordingly, the heat is reflected and water vapor and other gaseous materials are prevented or at least partially inhibited from recombining with the food in liquid form. Thus at least partially preventing a steaming hot pizza from becoming a cold soggy pizza.

In one embodiment, the radiant barrier is placed in the food transportation container. In a more preferred embodiment, the food transportation container comprises a box, wherein the second layer of the radiant energy barrier is attached to at least the top of the container, more preferably to the bottom of the container and/or on the sides of the container. As previously described, the radiant barrier may also be employed in the interior, middle, and exterior portions defining food container 20, including combinations of the forgoing.

As shown in FIGS. 1 and 2 for example, the food transportation container may comprise a box or other structure having a radiant barrier contained within it. In another embodiment, the food transportation container comprising the radiant energy barrier disclosed above, wherein the barrier is itself configured and dimensioned to define an interior space having an opening. For example, a metallized cardboard may be employed as a pizza box or a metallized cloth bag may be employed to contain the pizza box or other food item therein, for example. In addition, the container is preferably flexible, thin, and lightweight enough to be easily folded up when desired. It is also preferred that it be inexpensive, and recyclable as a unit so that it is may be readily disposed of without negatively impacting the environment. Additionally, the container is also contemplated to be capable of having indicia printed thereon. The indicia may include advertising materials, trademarks, and the like.

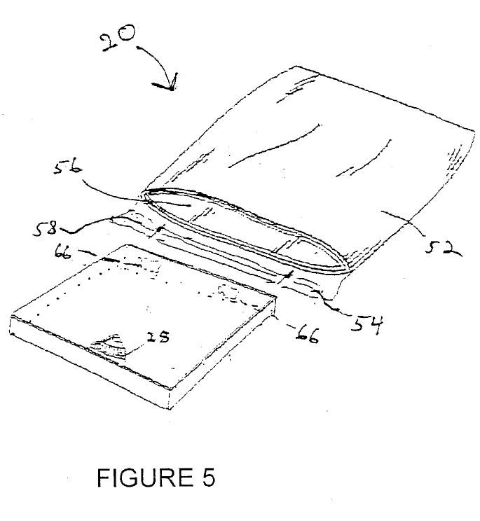

As shown in FIG. 5, one such embodiment includes the radiant energy barrier being configured to form a deformable bag 52 having an opening on at least one end, and preferably also includes a means of at least partially sealing the bag once the food is placed within, wherein sealing includes a reversible type sealing and/or a more permanent sealing means.

Sealing of the bag may be accomplished by using a flap portion 54 positioned on the side of the second layer opposite the interior space 56. The flap 54 comprising an attaching means 58, wherein the flap 56 and attaching means 58 are configured and dimensioned to be usable to at least partially seal the opening of the container 52. The attaching means 58 can be an adhesive, a hook and loop fastener (i.e., Velcro available from Velcro USA, Inc. Manchester N.H.), a chord, a zipper, or a combination comprising at least one of the foregoing.

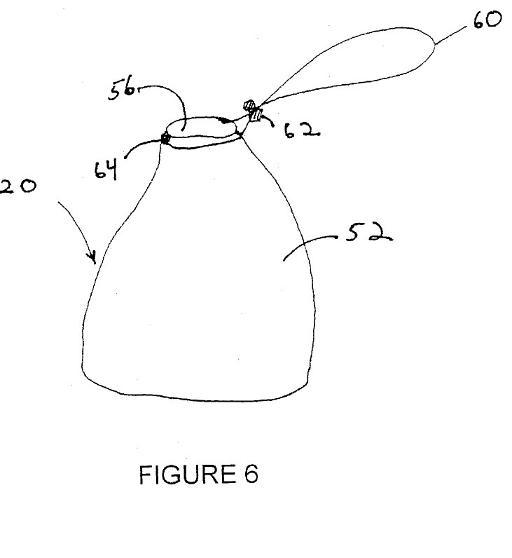

As shown in FIG. 6, the food transportation container 20 may also include a drawstring 60 attached to surface of the container 20, and/or disposed within a channel 64 located on a surface of the container, or a combination comprising at least one of the foregoing, wherein the drawstring is usable to at least partially seal the container opening, preferably with a clasping mechanism 62 to hold the opening closed once activated.

As shown in FIGS. 5 and 6, the embodiments discussed above may also be used in tandem, as for example, the container including a box having a radiant energy barrier 40 located within the deformable bag 52 comprising a radiant energy barrier 40. The box may also be modified to contain vents 66 disposed in the box to provide fluid contact between the box interior space 28 and the interior space of the bag 56. When the deformable bag is used, the radiant energy barrier of the box may not be present.

In use, a food item having a temperature different from a temperature of an external environment is placed into the food transportation container 20 and transported to its intended place, wherein the container 20 can comprise a single container (i.e., a box or a bag), or a plurality of containers used in combination (i.e., a box in a bag) as disclosed above.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A food transportation container comprising an interior space defined within an arrangement of a top, a bottom, and a plurality of sides; and
a radiant energy barrier disposed within the interior space of the container, the radiant energy barrier configured to minimize at least one of convection loss and conduction loss from the interior space;
the radiant energy barrier comprising a first layer at least partially separated from a second layer by an air space, wherein the first layer, the second layer, or both layers comprise a material capable of reflecting radiant energy, and wherein the airspace is in fluid communication with the interior space of the container through a plurality of perforations disposed within the first layer, the second layer, or both layers of the radiant energy barrier.

2. The food transportation container of claim 1, wherein the top is removably attached to the container.

3. The food transportation container of claim 1, wherein the top is hingedly attached to at least one side of the container, and wherein the top is releasably interconnected with at least one side of the container.

4. The food transportation container of claim 1, wherein the second layer of the radiant energy barrier is attached to the top of the container.

5. The food transportation container of claim 1, wherein at least one of the layers comprises at least one of a metallized polymeric sheet, metallized cardboard, and metallized cloth.

6. The food transportation container of claim 5, wherein the metallized polymeric sheet is about 2.5 to about 250 micrometers thick.

7. The food transportation container of claim 5, wherein the metallized polymeric sheet includes a thermosetting resin, an elastomeric resin, a thermoplastic resin, or a combination comprising at least one of the foregoing.

8. The food transportation container of claim 5, wherein the metallized polymeric sheet includes aluminum, and a polymeric resin selected from the group consisting of: an alkyd, a diallyl phthalate, an epoxy, a melamine, a phenolic, a polyester, an urethane, a rigid silicone, an acrylate, a butyl, a chlorosulfonated polyethylene, a fluorocarbon, a fluorosilicone, a polysulfide, a polyurethane, a neoprene, a nitrile, a silicone, a styrene, a butadiene, an acetate, an acrylic, a cellulosic, a chlorinated polyether, a fluorocarbon, a nylon, a polycarbonate, a polyethylene, a polypropylene, a polyimide, a polyphenylene oxide, a polystyrene, a polysulfone, a vinyl, and a combination comprising at least one of the foregoing polymeric resins.

9. The food transportation container of claim 1, wherein at least one of the layers further comprises a thermal convection barrier.

10. The food transportation container of claim 9, wherein the thermal convection barrier comprises polyethylene, polypropylene, or a combination comprising at least one of the foregoing.

11. The food transportation container of claim 1, wherein a perforation has a major axis having a length of about 1 to about 25 millimeters.

12. The food transportation container of claim 1, wherein at least one of the layers comprises a laminate.

13. The food transportation container of claim 1, wherein at least one of the layers comprises a monoaxially oriented polymeric sheet, a biaxial oriented polymeric sheet, or a combination comprising at least one of the foregoing.

14. The food transportation container of claim 1, wherein both layers each have perforations disposed within, and wherein a perforation disposed within the first layer has a larger defined surface area than the defined surface area of a perforation disposed in the second layer.

15. The food transportation container of claim 14, further comprising an absorbent layer disposed between the first and second layers, the absorbent layer configured to limit the amount of condensed fluid entering the interior space.

16. The food transportation container of claim 1, wherein at least one of the layers comprises a metallized polymeric sheet comprising aluminum and an oriented polypropylene polymeric sheet having a thickness of about 1 to about 5 micrometers.

17. A food transportation container comprising a radiant energy barrier configured and dimensioned to define an interior space having an opening the radiant energy barrier configured to minimize at least one of convection loss and conduction loss from the interior space;
the radiant energy barrier comprising a first layer at least partially separated from a second layer by an air space, wherein the first layer, the second layer, or both layers comprise a material capable of reflecting radiant energy, and wherein the airspace is in fluid communication with the interior space of the container through a plurality of perforations disposed within the first layer of the radiant energy barrier.

18. The food transportation container of claim 17, wherein the container is configured as an enveloping deformable bag.

19. The food transportation container of claim 17, further comprising a flap portion positioned on the side of the second layer opposite the interior space;
the flap comprising an attaching means, wherein the flap and attaching means are configured and dimensioned to be usable to at least partially seal the opening of the container.

20. The food transportation container of claim 19, wherein the attaching means is an adhesive, a hook and loop fastener, a chord, a zipper, or a combination comprising at least one of the foregoing.

21. The food transportation container of claim 17, further comprising a drawstring attached to surface of the container, disposed within a channel located on a surface of the container, or a combination comprising at least one of the foregoing, wherein the drawstring is usable to at least partially seal the container opening.

22. The food transportation container of claim 17, wherein at least one of the layers comprises a metallized polymeric sheet.

23. The food transportation container of claim 22, wherein the metallized polymeric sheet is about 0.01 to about 20 micrometers thick.

24. The food transportation container of claim 22, wherein the metallized polymeric sheet includes a thermosetting resin, an elastomeric resin, a thermoplastic resin, or a combination comprising at least one of the foregoing.

25. The food transportation container of claim 22, wherein the metallized polymeric sheet includes aluminum, and a polymeric resin selected from the group consisting of: an alkyd, a diallyl phthalate, an epoxy, a melamine, a phenolic, a polyester, an urethane, a rigid silicone, an acrylate, a butyl, a chlorosulfonated polyethylene, a fluorocarbon, a fluorosilicone, a polysulfide, a polyurethane, a neoprene, a nitrile, a silicone, a styrene, a butadiene, an acetate, an acrylic, a cellulosic, a chlorinated polyether, a fluorocarbon, a nylon, a polycarbonate, a polyethylene, a polypropylene, a polyimide, a polyphenylene oxide, a polystyrene, a polysulfone, a vinyl, and a combination comprising at least one of the foregoing polymeric resins.

26. The food transportation container of claim 17, wherein at least one of the layers further comprises a thermal convection barrier.

27. The food transportation container of claim 26, wherein the thermal convection barrier comprises polyethylene, polypropylene, or a combination comprising at least one of the foregoing.

28. The food transportation container of claim 17, wherein a perforation has a major axis having a length of about 1 to about 25 millimeters.

29. The food transportation container of claim 17, wherein at least one of the layers comprises a laminate.

30. The food transportation container of claim 17, wherein at least one of the layers comprises a monoaxially oriented layer, a biaxial oriented layer, or a combination comprising at least one of the foregoing.

31. The food transportation container of claim 17, wherein at least one of the layers comprises a metallized polymeric sheet comprising aluminum and an oriented polypropylene polymeric sheet having a thickness of about 1 to about 5 micrometers.

32. A method for reducing heat transfer in a food item during transportation of the food item, comprising:
inserting a food item having a temperature different from a temperature of an external environment into a food transportation container; and
transporting the food item within the container, wherein the container comprises a first container, a second container or a combination comprising at least one of the foregoing:
the first container comprising an interior space defined within an arrangement of a top, a bottom, and a plurality of sides; and
an internal radiant energy barrier disposed within the interior space of the first container, the internal radiant barrier configured to minimize at least one of convection loss and conduction loss from the interior space;
the internal radiant energy barrier comprising a first layer at least partially separated from a second layer by an air space, wherein the first layer, the second layer, or both layers comprise a material capable of reflecting radiant energy, and wherein the airspace between the two layers is in fluid communication with the interior space of the first container through a plurality of perforations disposed within the first layer, the second layer, or both layers of the internal radiant energy barrier;
the second container comprising an external radiant energy barrier configured and dimensioned to define an second interior space within the second container and having an opening, the external radiant barrier configured to minimize at least one of convection loss and conduction loss from the interior space;
the second radiant energy barrier comprising an inner layer at least partially separated from an outer layer by an air space, wherein the inner layer, the outer layer, or both layers comprise a material capable of reflecting radiant energy, and wherein the airspace between the two layers is in fluid communication with the interior space of the second container through a plurality of perforations disposed within the inner layer of the external radiant energy barrier.
